(19) United States
(12) Patent Application Publication
(10) Pub. No.: US 2013/0058188 A1
(43) Pub. Date: Mar. 7, 2013

(54) SPINDLE FOR MIXING FROZEN DESSERT

(71) Applicant: Asbjorn Hansen, SR., Drammen (NO)

(72) Inventor: Asbjorn Hansen, SR., Drammen (NO)

(73) Assignee: MARIENLYST EIENDOM AS, Drammen (NO)

(21) Appl. No.: 13/223,854

(22) Filed: Sep. 1, 2011

(51) Int. Cl. B01F 7/00

(52) U.S. Cl. 366/279

(57) ABSTRACT

A spindle for mixing frozen desserts in a closed mixing chamber formed by a funnel and a top chamber, wherein the spindle is accommodated in the top chamber with a driver for rotating the spindle, has an auger thread revolving around the centre axis of the spindle making a conical helix from the tip of the spindle and along a portion of the spindle in the axial direction. A thread is made in an unbroken embodiment with several cuts partly into the thread.

### FIELD OF THE INVENTION

The present invention describes details of an apparatus for mixing and blending ice cream and other frozen desserts. More specifically the invention describes details of a spindle for a mixing apparatus.

### BACKGROUND OF THE INVENTION

A mixing apparatus for mixing ice cream and other frozen desserts with one or more additives typically comprises a funnel for holding the frozen dessert and additives, a spindle for creating a mixing action, a spindle driver for rotating the spindle, and a linear actuator for relative movement of the funnel and spindle into a position in which the spindle is telescoped into the funnel, in which position a rotation of spindle will mix the different ingredients of the frozen dessert.

### SUMMARY

Around 1996, the applicant developed the first prototype of a spindle for frozen desserts. It was a conical spindle with continuous threads. The spindle was connected to an electrical motor. During testing with the prototype various challenges were encountered. One of theses was that the ice cream mix would not always dispense from the spindle. Another was that the motor was not strong enough to mix fruit and the ice cream. This would typically occur if the temperature of the ice cream was too cold or if the fruit mix was too hard, for example with frozen strawberries. The motor driving the spindle up and down was further not strong enough if the ice cream/fruit was too cold.

The ice cream would dispense too quickly if the spindle was washed just before being used, because the friction between the spindle and the surface of the mixing house probably was too small. Further that the ice cream would stick to the spindle when it was cold leaving a portion of the product mix sticking to the spindle.

The geometry of the spindle was more or less similar through different development stages until about 2007 when work for improving the spindle started.

When working with improving the spindle different parameter of the mixing apparatus where changed and tested. The temperature of the ice cream was maintained above −18° C. The amount of sugar in the ice cream was increased to soften the ice cream. The temperature and amount of the fruit were decreased. The mixing house was insulated to maintain a steady temperature of the surface in order to keep constant friction. The motor power driving the spindle was increased.

After testing the different parameters, we found that there still were several weaknesses with the mixing apparatus. To dispense the product completely we had to change the rotational speed of the spindle during dispensing. However, sometimes the product would still not dispense even at full speed. The mixing of the ice cream and fruit was not always satisfactory. Sometimes the ice cream would dispense too early before it was properly mixed with the fruit. The temperature of the ice cream was also a challenge. Although the power of the motor driving the spindle was increased, the force required for mixing was sometimes too large for the machine to handle.

The focus was then changed to the design of the spindle itself for improving mixing and disposing of the mixed product. Several changes of the spindle were made and tested. The diameter of the spindle was increased, and cuts were made in the spindle. The idea of making cuts was to make the “cutting” of the ice cream and fruit more effective. We found that the power required is less and the stress on the machine is less. Several designs of the spindle were tested. Among these were a few cuts half way into the threads; many cuts half way into the threads; many cuts full into the threads; varying the number of cuts, and experimenting with cutting the threads at an angle such that the cuts were more effective.

Testing showed that if there are too many cuts, the ice cream mix will not dispense, i.e. it is left in the spindle. If the cuts are too narrow, washing the spindle may become difficult.

The following disclosure relate to a spindle for a mixing apparatus for making ice cream. The apparatus and spindle described is however well suited for mixing other types of desserts.

One or more embodiments of the present invention provides a spindle for a mixing apparatus with improved mixing and dispensing properties.

According to one or more embodiments of the present invention, a spindle for mixing frozen desserts in a closed mixing chamber is formed by a funnel and a top chamber, the spindle is accommodated through said top chamber with driver means for rotating the spindle, said spindle comprises an auger thread revolving around the centre axis of the spindle making a conical helix from the tip of the spindle and along a portion of the spindle in the axial direction, and where the thread of the spindle is made in a continuous embodiment with several cuts partly into the thread.

It should be understood that the detailed description and specific examples, while indicating embodiments of the spindle are given by way of illustration only, since various changes and modifications within the spirit and scope of the invention will become apparent to those skilled in the art.

### BRIEF DESCRIPTION OF THE DRAWINGS

FIG. 1 shows an overall view of a spindle according to one or more embodiments of the invention;

FIG. 2A shows details of a cut in the thread that is V-shaped;

FIG. 2B shows details of a cut in the thread that is U-shaped, and

FIG. 3 shows that a profile of a cut in the thread.

### DETAILED DESCRIPTION

Embodiments of the invention will be described below with reference to the accompanying drawings. In embodiments of the invention, numerous specific details are set forth in order to provide a more thorough understanding of the invention.

However, it will be apparent to one of ordinary skill in the art that the invention may be practiced without these specific details. In other instances, well-known features have not been described in detail to avoid obscuring the invention.

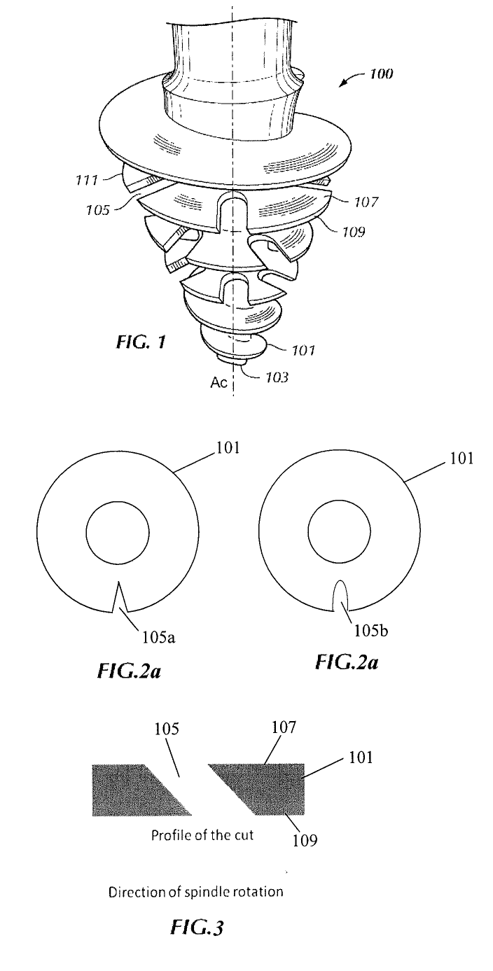

FIG. 1 shows an overall view of a spindle 100 according to one or more embodiments of the invention. The main functions of the spindle 100 is mixing frozen desserts in a closed mixing chamber formed by a funnel and a top chamber and to dispense the dessert through a valve in the funnel part of the mixing chamber. The spindle 100 is accommodated through said top chamber, and rotated by driving means. The spindle 100 comprises an auger thread revolving around the centre axis Ac of the spindle 100 making a conical helix from the tip 103 of the spindle 100 and along a portion of the spindle 100 in the axial direction. The spindle 100 is characterised in that a thread 101 is made in an unbroken embodiment with several cuts 105 partly into the thread 101.

In one embodiment, the cuts 105 in the thread 101 are V-shaped 105a or U-shaped 105b ref. FIGS. 2A and 2B. A combination of V-shaped and U-shaped cuts 105a, 105b is also feasible. Each cut 105 has a width between 5-20 mm according to one or more embodiments of the present invention.

The cuts 105 are further made at an angle relative to the upper face 107 and lower face 109 of the thread 101 such that the part of the cuts 105 on the lower face 109 of the thread acts as a cutting blade when the spindle 100 is rotating, ref. FIG. 3.

In one embodiment, the cuts 105 are provided in the thread 101 where the outer diameter of the thread exceeds a predetermined measurement, e.g. more that 720 degrees from the tip 103 of the spindle 100.

In one embodiment the cuts 105 are placed a distance between 60° and 90° from each other, i.e. from 4 to 6 cuts per 360°. The number of cuts 105 can be increased when the diameter of the spindle 100 increases. However, mixing rarely takes place above the fourth thread 111.

In one embodiment the pitch of the threads 101 revolving around the centre axis Ac of the spindle 100 is varying between 10-30 mm.

Different thicknesses of the thread 101 have been studied, and it is found that a thickness between 2-4 mm is advantageous. The thickness of the thread 101 can also vary along the axis Ac of the spindle 100.

For a man skilled in the art it is obvious that he invention described above can be varied in many ways. Such variations are not to be regarded as a departure from the spirit and scope of the invention, and all such modifications as would be obvious are intended to be included within the scope of the following claims.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A spindle for mixing frozen desserts in a closed mixing chamber formed by a funnel and a top chamber, wherein the spindle is accommodated in said top chamber with driver means for rotating the spindle, said spindle comprising:
an auger thread revolving around the centre axis of the spindle making a conical helix from the tip of the spindle and along a portion of the spindle in the axial direction,
wherein a thread is made in an unbroken embodiment with several cuts partly into the thread.

2. The spindle according to claim 1, wherein said cuts in the thread are V-shaped or U-shaped.

3. The spindle according to claim 1, wherein said cuts in the thread are made at an angle relative to the upper and lower face of the thread such that the part of the cuts on a lower face of the thread acts as a cutting blade when the spindle is rotating.

4. The spindle according to claim 1, wherein said cuts are provided in the thread where the outer diameter of the thread exceeds a predetermined measurement.

5. The spindle according to claim 4, wherein the predetermined measurement is more that 720 degrees from the tip of the spindle.

6. The spindle according to claim 1, wherein said cuts into the thread are placed a distance between 60° and 90° from each other.

7. The spindle according to claim 1, wherein a pitch of the threads revolving around the centre axis of the spindle is varied.

8. The spindle according to claim 1, wherein a pitch of the threads is between 10-30 mm.

9. The spindle according to claim 1, wherein a thickness of the thread is varied along the axis of the spindle.

10. The spindle according to claim 1, wherein a thickness of the thread is between 2-4 mm.
